(19) United States
(12) Patent Application Publication
(10) Pub. No.: US 2014/0335276 A1
(43) Pub. Date: Nov. 13, 2014

(54) METHODS OF PREVENTING OR COUNTERACTING CRYSTALLINE DEPOSITS OF SUBSTRATES

(71) Applicant: CeraNovis GmbH, Saarbrucken (DE)

(72) Inventors: Stefan Faber, Saarbrucken (DE); Bernhard Schillo, Neunkirchen (DE); Olaf Binkle, Kirkel (DE); Ralph Nonninger, Saarbrucken (DE); Dimitrina Lang, Neunkirchen (DE); Jürgen Hopf, Ottweiler (DE); Frank Kleine Jäger, Bad Durkheim (DE); Bernd Rumpf, Hockenheim (DE); Markus Förster, Gonnheim (DE)

(21) Appl. No.: 14/337,365

(22) Filed: Jul. 22, 2014

Related U.S. Application Data
(62) Division of application No. 12/281,656, filed on Nov. 4, 2008, now abandoned.

(30) Foreign Application Priority Data
Mar. 10, 2006 (DE) 102006012906.7

(51) Int. Cl. B05D 5/00

(52) U.S. Cl. CPC B05D 5/00
USPC 427/387; 427/372.2

(57) ABSTRACT

A method of counteracting crystalline deposits on a surface includes applying a sprayable low-viscosity suspension including a binder system including at least one organosilicon constituent selected from the group consisting of alkylpolysiloxane, alkylsilicone resin and phenylsilicone resin; ceramic particles; hexagonal boron nitride particles; optionally, process additives; and at least one solvent to the surface and curing the suspension.

### TECHNICAL FIELD

This disclosure relates to layers or coatings which counteract crystalline deposits on a substrate, to compositions for producing such layers or coatings, to processes of producing such layers or coatings, and to the use of boron nitride-containing compositions as a material for coating surfaces which come into contact with salt-containing solutions.

### BACKGROUND

As is well known, crystallization refers to the process of formation of crystals. This can proceed from a solution, a melt, the gas phase, an amorphous solid or else from another crystal (recrystallization), but always through crystal formation and crystal growth. A crystal is an anisotropic, homogeneous body which consists of a three-dimensionally and periodically arranged structural unit. So that a crystal can form, the crystallizing substance must first be brought to oversaturation. As the crystal forms, the previously dissolved molecules or elements become ordered in a regular form which is in some cases substance-specific.

Strongly adhering encrustations on substrates owing to the crystallization of salts from aqueous solution have been known for a long time and lead to massive problems in many sectors. Known examples thereof are the scaling of boilers owing to the temperature-dependent calcium hydrogen carbonate/calcium carbonate equilibrium, which leads to them having to be cleaned regularly to ensure that they work. In general, chemical (e.g., acids) or mechanical processes are used. Prophylaxis of crystallization through the use of distilled water or addition of complexing agents such as EDTA or else ion exchangers is possible only in closed vessels, but cannot be performed, for example, in large-surface area open or flow systems with high salt concentration.

In other sectors of industry too, such phenomena (known by terms including crystallization fouling) are encountered frequently. For example, salt crusts, which become firmly adhering with time, are difficult to remove and can additionally also promote corrosion in the case of metallic surfaces, form in evaporator plants for seawater desalinification, heat exchangers in industrial plants or cooling water flow systems on surfaces which are in contact with salt-containing solutions. Salt crusts on thermostats, heating elements or flow heaters additionally greatly hinder the transfer of heat.

In power plants or refuse incinerators, substances or reaction products from the flue gas desulfurization plant are frequently entrained as fine solid droplets by the flue gas. As the aerosol passes through the vapor gas preheater, owing to the evaporation of liquid, salts (usually sulfates) are deposited on the heat exchange tube. These deposits can lead with time to the blockage of the plant and thus necessitate its shutdown. The tubes therefore have to be cleaned in a complicated manner at regular intervals, which of course impairs the operation of the plant and is associated with a high level of inconvenience and cost.

The prior art discloses coatings which prevent spot formation owing to the evaporation of rainwater on surfaces. For instance, U.S. Pat. No. 6,013,724 and JP 10130581 disclose silane-based coatings which are intended to prevent soiling by evaporated rainwater. Such layers, however, are of low abrasion and long-term stability. They are therefore unsuitable for use in vapor gas preheaters or saltwater evaporator plants.

So-called “easy to clean” coatings based on fluorosilane, as described in DE 195 44 763 A1 or EP 587 667 B1 are capable in principle of allowing water to run off, but cannot be used to prevent deposits by salt crystallization on surfaces. Firstly, the typical layer thickness at 5-10 μm is much too low to be durable under the usually abrasive conditions of a crystallization from flowing, salt-containing solutions. Secondly, these layers swell up in aqueous solution with time, as a result of which they lose their effect. Furthermore, the fluorine groups which cause the effect are localized only on the surface of the layer, which means that no further water can be repelled after the erosion of the uppermost layer. Expensive teflonization of metal surfaces with a PTFE layer is likewise unsuitable for bringing about a long-lasting anticrystallization effect.

It could therefore be helpful to provide a technical solution which does not have the known disadvantages. Such a solution should enable prevention or at least significant hindrance of deposits of the crystalline type, especially of salts, on surfaces. The focus should lie more particularly on the protection of moist surfaces or surfaces immersed permanently in water.

### SUMMARY

We provide a layer or coating which counteracts crystalline deposits on a substrate including a matrix composed of a binder system and ceramic particles, and boron nitride in particle form, wherein the boron nitride particles are incorporated into the matrix and distributed essentially homogeneously therein.

We also provide a composition for producing the layer or coating including a binder system, ceramic particles, boron nitride in particle form, optionally process additives and at least one solvent.

We further provide a method of preventing deposits from a solution on a surface of a substrate including coating the surface with a boron nitride-containing composition.

We further yet provide a substrate that at least partially contacts salt-containing water provided at least partly with the layer or coating.

We still further provide a method of counteracting crystalline deposits on a surface including applying a sprayable low-viscosity suspension including a binder system including at least one organosilicon constituent selected from the group consisting of alkylpolysiloxane, alkylsilicone resin and phenylsilicone resin; ceramic particles; hexagonal boron nitride particles; optionally, process additives; and at least one solvent to the surface and curing the suspension.

### DETAILED DESCRIPTION

Our layer or coating comprises a matrix composed of a binder system and ceramic particles, and also boron nitride in particle form.

We found that, surprisingly, such a layer or coating prevents or at least counteracts crystalline deposits even at room temperature. It is especially suitable for substrates with surfaces of metal, glass, ceramic, enamel or even plastic. It is notable for good adhesion to the surface and high abrasion stability. Its functionality is ensured even at room temperature, and it has a long lifetime.

The boron nitride particles are preferably hexagonal boron nitride. The boron nitride particles are incorporated into the matrix and are distributed essentially homogeneously therein. As a result, the inventive layer, in contrast to an “easy to clean” surface, also remains capable of working if the surface of the layer should be partly eroded in the course of time.

The high abrasion stability of the layer or coating is ensured primarily by the matrix composed of the binder system and the ceramic particles. In this context, ceramic particles should be understood in the widest sense to mean particles formed from inorganic compounds, which are preferably present partly in crystalline form.

The binder system of our layer or coating preferably has at least one (hardened or cured) organic binder. The at least one organic binder can be used, for example, in the form of aqueous emulsions or dispersions and contributes to the consolidation and compaction of the layer or coating to be produced.

The at least one organic binder may comprise an acrylic-based binder.

The at least one organic binder may also comprise at least one organosilicon constituent. This comprises, more particularly, at least one member from the group of the polydimethylsiloxanes comprising preferably alkylpolysiloxane, alkylsilicone resin and phenylsilicone resin.

Furthermore, it is preferred when the at least one organic binder comprises at least one silicone polyester resin.

It is particularly preferred that, for the layer or coating, a binder system is selected which is curable below about 250° C., preferably below about 150° C., especially at room temperature. This has the advantage that no separate curing step at very high temperatures is required in the production of the layer or coating, and so no employment of high temperatures is needed for the curing and the layer can also find use on thermally unstable substances, for example, on plastics substrates. Retrofitting of already existing plants can thus also be realized more easily.

It may, though, also be preferred that the binder comprises at least one inorganic binder.

Such a binder system is preferred especially when it comprises inorganic nanoparticles, especially those having a mean particle size of <100 nm. More preferably, the nanoparticles have a mean particle size of below about 50 nm, especially below about 25 nm.

The nanoparticles are especially oxidic particles, especially at least one member from the group comprising aluminum oxide, zirconium oxide, boehmite and titanium dioxide particles.

In contrast to organic binder systems, binder systems comprising purely organic binders generally require curing or consolidation at comparatively much higher temperatures (sintering temperatures). This limits the field of application to the extent that they are unsuitable for coatings of substrates of relatively low thermal stability, for example, those of plastic. On the other hand, an layer or coating with a purely inorganic binder system is exceptionally stable to high temperatures, and so it is suitable especially for coating substrates on which these demands are made.

Particular preference is also made to a layer or coating when it comprises a binder system which comprises a combination of at least one organic and at least one inorganic binder. Such a “hybrid binder system” generally requires, to achieve an initial strength, a curing step at the temperatures which are needed to cure the organic binder system, i.e., for example, at room temperature.

The ceramic particles of the matrix of a layer or coating preferably have a mean particle size between about 0.2 μm and about 5 μm.

The ceramic particles are preferably oxidic particles, especially aluminum oxide and/or titanium dioxide particles.

The ceramic particles may be aluminosilicate particles. Among these, particular emphasis is given to feldspars and zeolites. Kaolin should also be mentioned as preferred, this being known to be a rock material which comprises kaolinite, a weathering product of feldspar, as the main constituent.

For the boron nitride particles in a layer or coating too, a particular mean particle size is preferred. This is especially between about 0.2 μm and about 5 μm.

A layer or coating preferably has a thickness in the range between about 10 μm and about 150 μm, preferably of approximately 50 μm. A thickness in this range ensures, even in the case of high mechanical stresses on the layer or coating, a long lifetime.

A layer or coating counteracts the adhesion of salts of all kinds, for example, of sodium chloride, sea salt, halides, especially chlorides, bromides, fluorides, sulfates, phosphates, carbonates, hydrogencarbonates, hydrogenphosphates, preferably of CaSO₄ and lime. It is particularly suitable for moist surfaces or surfaces immersed permanently in water or flowed over by water. According to the binder system used, this coating or layer can be cured or consolidated at room temperature or comparatively low temperatures. This is especially true of coatings comprising organic binder systems or the aforementioned “hybrid binder systems” comprising a combination of at least one organic and at least one inorganic binder. When crystalline deposits form on a layer or coating, they are comparatively easy to remove.

Even from solutions with high salt concentrations, as occur, for example, in evaporator systems for seawater desalinification or flow systems comprising cooling water from rivers or lakes, no firmly adhering salt crusts form with the coating on the layers provided with the layer or coating.

Furthermore, a layer or coating also counteracts the deposition of salts in conjunction with ashes, which can lead to problems, for example, in vapor gas preheaters, as has already been mentioned at the outset. A layer or coating can therefore also be used in the vapor gas preheater power plant sector. The caking tendency on the heat exchanger tubes is reduced as a result, which prolongs the run time of the plant and facilitates the cleaning of the tubes.

We likewise provide compositions for producing a layer or coating which counteracts crystalline deposits.

A composition comprises:
a binder system,
ceramic particles,
boron nitride in particle form,
optionally process additives and
at least one solvent.

As already mentioned, the binder system of a composition may be an organic binder system, an inorganic binder system or a “hybrid binder system.” All of these systems have already been defined in detail in the context of the description of a layer or coating. To avoid repetition, reference is hereby made explicitly to the corresponding parts of the description.

The same also applies to the preferred ceramic particles and to the boron nitride particles which are preferably present in a composition and have likewise already been described above.

The at least one solvent in a composition is preferably a polar solvent, especially water. In principle, however, alternatively or additionally, further polar components, for example, alcohols, may also be present.

In many cases, it is, however, desirable to very substantially dispense with organic constituents in the solvent. For instance, when organic solvents are used, owing to their low vapor pressure, there is in principle always the risk of fire.

Accordingly, the composition may comprise a solvent which is free of nonaqueous liquid constituents.

As process additives, it is possible for known additives to be present in the composition, for example, dispersants, defoamers, leveling agents, cobinders or thickeners to adjust the viscosity.

The composition preferably has a solids content between about 30% by weight and about 50% by weight, especially of approximately 40% by weight. The amount of the suspension medium present in the composition is not critical and can be varied according to the use of the composition. The composition may be present in the form of a low-viscosity, especially spreadable or sprayable suspension.

The composition comprises boron nitride, based on the solids content, preferably in a proportion of from about 5% by weight to about 50% by weight, especially from approximately 10% by weight to approximately 15% by weight.

The ceramic particles are present in the composition, based on the solids content, especially in a proportion of from about 5% by weight to about 50% by weight, especially from approximately 10% by weight to approximately 20% by weight.

The composition is notable for ease of application. It can be sprayed or spread onto a substrate or be applied by dipping or flow coating. Depending on the binder system used, after the application, it merely has to be dried, and if appropriate also subsequently cured at elevated temperature. Installed systems and plants can thus be retrofitted with a layer which counteracts crystalline deposits in a problem-free manner.

The use of a boron nitride-containing composition as a material for coating surfaces which come into contact with salt-containing media or solutions or drops or droplets also forms part of the subject matter of this disclosure.

The boron nitride-containing composition is suitable for use on surfaces of glass, ceramic, enamel, metal and plastic. It is accordingly suitable for coating heat exchanger systems, water pipes, parts of drinking water treatment plants, evaporator plants for seawater desalinification, cooling water circuits, cooling tubes containing river water for power plants, process and service water plants, sprayed areas, components of vapor gas preheaters and the like.

It is also possible to use a boron nitride-containing composition to coat fittings, thermostats, heating coils, flow heaters, water tanks and the like for protection from scale deposits.

In addition, we provide that any object provided with an layer or coating, more particularly coated. It is unimportant whether the object is only partly or else fully coated with the layer or coating.

More particularly, we also provide a water treatment plant, seawater desalinification plant or the like, which has components which come into contact with salt-containing water and have been provided at least partly with a boron-nitride-containing layer.

A layer or coating is produced on a substrate by a process by application of a boron nitride-containing composition to the substrate and subsequent curing.

The curing is effective preferably at comparatively low temperatures, preferably at temperatures of <250° C., especially at room temperature.

Further features are evident from the description which follows of preferred aspects. At the same time, the individual features, each alone or several in combination with one another, can be implemented as desired. The particular aspects described serve merely for illustration and for better understanding and should in no way be interpreted as limiting.

### EXAMPLE 1

A preferred composition comprises, as well as water as the solvent, the following components:
37.5 g of Joncryl® 8383 (from Johnson Polymer)
37.5 g of Joncryl® 8300 (from Johnson Polymer)
150 g of titanium dioxide suspension (from Kronos)
150 g of boron nitride suspension (from Saint-Gobain)
42 g of silicon binder
2.085 g Tego® Protect 5100 (from Tego Chemie)
4.17 g Tego® ViscoPlus 3000 (from Tego Chemie).

The titanium dioxide suspension comprises the following components:
100 g of demineralized water
2.448 g of EFKA® 4530 (from Efka Additives)
68 g of TiO₂ (from Kronos)
0.068 g Surfynol® 104 BC (from Air Products).

To prepare the titanium dioxide suspension, EFKA® 4530 and water are mixed with stirring. After 30 minutes, the TiO₂ is added. Thereafter, Surfynol® 104 BC is added and the mixture is stirred for a further 2 hours. Subsequently, the mixture is ground in a bead mill. The suspension is storable and should be stirred up thoroughly before use.

The boron nitride suspension comprises the following components:
100 g of demineralized water
11.1 g of EFKA® 4530
74 g of boron nitride (from Saint-Gobain).

To prepare the boron nitride suspension, EFKA® 4530 and water are mixed with stirring. After 30 minutes, the boron nitride is added and the mixture is stirred for 2 hours. Subsequently, the mixture is ground in a bead mill with stirring. (The particle size in the finished suspension should be below 1 μm.) The suspension is storable and should be stirred up thoroughly before use.

The silicon binder comprises the following components:
2 g of 3-aminopropylmethyldiethoxysilane (from Brenntag)
0.376 g of hydrochloric acid (0.1 molar)
36.40 g of Silres® MP 42 E (from Wacker Chemie)
3.64 g of Tego® Protect 5100
1.82 g of demineralized water.

To prepare the silicon binder, the hydrochloric acid is added dropwise to 3-aminopropylmethyldiethoxysilane and the mixture is stirred for 24 hours. This forms a hydrolysate. Silres® MP 42, Tego® Protect 5100 and water are mixed with one another and stirred for at least 12 hours. 1.82 g of the hydrolysate are added dropwise to this emulsion and the mixture is stirred for 24 hours.

The silicon binder mixture is not storable and should be processed directly.

To prepare the final composition (see above), Joncryl® 8383 and Joncryl® 8300 (acrylic-based bonders) are mixed with stirring. Subsequently, the titanium dioxide suspension and the boron nitride suspension are added. The mixture is stirred for 4 hours. Thereafter, the silicon binder is slowly added dropwise and the mixture is stirred for 24 hours. After Tego® Protect 5100 has been added in portions, the mixture is stirred for 3 hours and, after Tego® ViscoPlus 3000 has been added, for a further 24 hours.

The composition can be applied to a substrate, for example, metal plate, stainless steel plate, for example, by spraying, dipping, flow coating or brush application. After drying at room temperature, the resulting layer or coating is ready for use.

Owing to the low temperatures in the course of cursing, such a composition is particularly suitable for thermally unstable substrates, especially those made of plastic.

Optionally, however, further curing can also be effected at higher temperatures (<200° C.).

### EXAMPLE 2

A further composition comprises, as well as water as a solvent, the following components:

| Component | | Amount in |
|---|---|---|
| No. | | % by wt. |
| 1 | BN (from Saint-Gobain) | 30.87 |
| 2 | Al₂O₃ (from Alcoa) | 15.43 |
| 3 | Phosphate glass (from Budenheim) | 12.00 |
| 4 | Polysiloxane binder (Silres ® MP 42 E) | 30.00 |
| 5 | Phosphatic corrosion protection based on zinc | 10.25 |
| | phosphate, calcium phosphate, aluminum | |
| | phosphate in phosphoric acid | |
| 6 | Byk ® 420/butylglycol (from Byk Chemie) | 1.15 |
| 7 | Acticide ® MBS as a preservative (from Thor) | 0.3 |

To prepare this composition, components 1, 2, 3 and 5 are first each dispersed separately in water with the aid of appropriate additives and ground up with the aid of a bead mill. Thereafter, the individual components of the coating system are initially charged in the above sequence and mixed with one another by simple stirring in water. The solids content of the composition is adjusted to approximately 40% by weight at the same time.

The composition can be applied to an appropriate substrate, for example, by spraying, dipping, flow coating or brush application. Drying at room temperature (or else at higher temperatures) is followed by the actual thermal consolidation of the coating at temperatures of >450° C. (over a period of 30 minutes).

### EXAMPLE 3

A further composition comprises, as well as water as a solvent, the following components:

| Component | | Amount in |
|---|---|---|
| No. | | % by wt. |
| 1 | Al₂O₃ (from Alcoa) | 36.79 |
| 2 | n-ZrO₂ (particle size 10 nm) | 8.17 |
| 3 | BN (from Saint-Gobain) | 20.68 |
| 4 | Byk ® 420/butylglycol | 1.03 |
| 5 | Inodur ® (from Inomat) | 33.0 |

To prepare this composition, components 1, 2 and 3 are first each dispersed separately in water with the aid of appropriate additives and ground up with the aid of a bead mill. Thereafter, components 1, 2 and 3 of the coating system are initially charged in the above sequence and mixed with one another by simple stirring. Components 4 and 5 are likewise mixed with one another and, after a brief activation time (approximately 10 min), added to the mixture of components 1, 2 and 3. The solids content of the composition is adjusted to approximately 40% by weight at the same time.

The composition can be applied to an appropriate substrate, for example, by spraying, dipping, flow coating or brush application. Drying at room temperature or temperatures up to 100° C. is followed by the actual thermal consolidation of the coating at 450-500° C. (over a period of 10 minutes).

### EXAMPLE 4

With explicit reference to the process procedure of the previous examples, a further preferred composition is prepared as follows.

In a stirred reactor, 41 g of a silicone polyester resin are initially charged and diluted with 33 g of butyl acetate. The mixture thus obtained is stirred at room temperature for 30 minutes. Subsequently, 5.55 g of pulverulent hexagonal boron nitride are added. The mixture obtained in this way is then ground in a ball mill which contains ZrO₂ grinding beads for 1 hour, then mixed further with 8.9 g of a perfluorinated wax. Thereafter, with the aid of a dissolver, 8.9 g of pulverulent calcined kaolin are added, and then the mixture is stirred for a further hour. After subsequent addition of a surface additive (polyether-modified polydimethylsiloxane, BYK-306) and a further hour of stirring, the resulting mixture can be applied in the manner already described in the previous examples to a substrate (e.g., metal plate, stainless steel plate). This application can be effected, for example, by spraying with a low-pressure pistol.

### EXAMPLE 5

In a glass reactor, a stainless steel substrate coated with a composition according to Examples 1 to 4 and an uncoated stainless steel substrate as a reference were each exposed to a saturated CaSO₄ solution. The CaSO₄ solution flowed constantly over the substrate. (The flow was generated by a stirrer; the fluorate was selected at a low level.) The temperature of the CaSO₄ solution was 80° C.

After 30 days, the CaSO₄ deposits formed by crystallization on the substrates were assessed. The substrates coated with the composition had a lower coverage with CaSO₄ by about a factor of 4 than the reference. It was already possible to visually discern significantly lower coverage than in the case of the uncoated comparative substrate. On the uncoated substrate, the CaSO₄ layer was significantly thicker. The layer on the stainless steel substrates coated with the composition could easily be cleaned off mechanically.

### EXAMPLE 6

Salt solutions of different concentration (CaCl₂/CaSO₄, table salt, table salt/CaCl₂) were concentrated by drying on steel surfaces coated with compositions according to Examples 1, 2, 3 and 4 (at 150° C. over a period of 3 h). Thereafter, the salt crusts were removed with a spatula (i.e., mechanically) or by rinsing with water.

In comparison to an uncoated substrate, the crusts were removable significantly more easily on the coated substrate. The coating itself remained unchanged.

### EXAMPLE 7

Substrates of mild steel, stainless steel and glass, which were 10×10 cm in size and had been coated with compositions according to Examples 1, 2, 3 and 4, were heated in a drying cabinet to 150° or 170° C. To each of these was added, with a pipette, an approximately 2-3 ml drop of a salt solution (calcium chloride, calcium sulfate, each 10% in water), which was concentrated by drying at room temperature. This formed a tablet-shaped salt crust. As a reference, a drop of salt solution was in each case also added to an uncoated substrate of mild steel, stainless steel and glass, and concentrated by drying.

The cooled substrate is assessed. It is always compared with uncoated plates. After cooling, the salt crusts adhered very firmly on the uncoated reference substrates and were removable with a spatula only with difficulty and also not without residue.

It was significantly easier to detach the crusts in the case of the coated surfaces. Under flowing water, the salt tablet is removed at a significantly earlier stage and without residue from the substrate (for the most part without dissolving).

1. A method of preventing deposits on a surface of a substrate comprising coating the surface with a boron nitride-containing composition.

2. The method as claimed in claim 1, wherein the boron nitride-containing composition comprises:
a binder system comprising at least one organosilicon constituent;
ceramic particles;
hexagonal boron nitride particles;
optionally, process additives; and
at least one solvent.

3. The method as claimed in claim 2, wherein the at least one organosilicon constituent is at least one constituent selected from the group consisting of alkylpolysiloxane, alkylsilicone resin and phenylsilicone resin.

4. The method as claimed in claim 2, wherein the at least one organosilicon constituent comprises at least one silicone polyester resin.

5. The method as claimed in claim 2, wherein the ceramic particles have a mean particle size of 0.2 μm to 5 μm.

6. The method as claimed in claim 2, wherein the ceramic particles are oxidic particles.

7. The method as claimed in claim 2, wherein the ceramic particles are aluminum oxide and/or titanium dioxide particles.

8. The method as claimed in claim 2, wherein the ceramic particles are aluminosilicate particles.

9. The method as claimed in claim 2, wherein the boron nitride particles have a mean particle size of 0.2 μm to 5 μm.

10. The method as claimed in claim 2, wherein the at least one solvent is water.

11. The method as claimed in claim 2, wherein the composition has a solids content of 30% by weight to 50% by weight.

12. The method as claimed in claim 11, wherein the composition comprises boron nitride, based on the solids content, in a proportion of from 5% by weight to 50% by weight.

13. The method as claimed in claim 1, wherein the substrate is a heat exchanger system, a water pipe, a part of a drinking water treatment plant, a seawater desalinification plant, a cooling water circuit, a cooling tube containing river water for power plants and a vapor gas preheater.

14. The method as claimed in claim 1, wherein the deposits are crystalline deposits.

15. The method as claimed in claim 1, wherein the deposits are deposits from solution.

16. The method as claimed in claim 1, wherein the surface is a surface that contacts salt-containing water.

17. The method as claimed in claim 1, wherein the composition is cured.

18. The method as claimed in claim 15, wherein the composition is cured below 250° C.

19. A method of counteracting crystalline deposits on a surface comprising applying a sprayable low-viscosity suspension comprising:
a binder system comprising at least one organosilicon constituent selected from the group consisting of alkylpolysiloxane, alkylsilicone resin and phenylsilicone resin;
ceramic particles;
hexagonal boron nitride particles;
optionally, process additives; and
at least one solvent
to the surface and curing the suspension.

20. The method as claimed in claim 19, wherein the surface is a surface of a heat exchanger system, a water pipe, a part of a drinking water treatment plant, a seawater desalinification plant, a cooling water circuit, a cooling tube containing river water for power plants or a vapor gas preheater.
